(19) United States
(12) Patent Application Publication
(10) Pub. No.: US 2008/0135699 A1
(43) Pub. Date: Jun. 12, 2008

(54) Garage door panel mounting systems and methods thereof

(75) Inventor: Michael D. Potter, Churchville, NY (US)

Correspondence Address: NIXON PEABODY LLP - PATENT GROUP, 1100 CLINTON SQUARE, ROCHESTER, NY, 14604, US

(73) Assignee: Nth Tech corporation, Churchville, NY (US)

(21) Appl. No.: 11/906,610

(22) Filed: Oct. 3, 2007

Related U.S. Application Data
(60) Provisional application No. 60/827,946, filed on Oct. 3, 2006.

(51) Int. Cl. A47F 5/08; E05C 19/00

(52) U.S. Cl. 248/205.1; 292/2

(57) ABSTRACT

A storage system for use on a garage door includes at least one retaining device and at least one latching device. The retaining device is attached to one of two or more panels of a garage door and the latching device is spaced from the retaining device and is attached to one of an item to be detachably secured and the one of the two or more panels of the garage door. The latching device has at least an engaged position which detachably secures an item to the one of two or more panels of the garage door with the retaining device and a detached position which releases the item from the one of two or more panels of the garage door.

This application claims the benefit of U. S. Provisional Patent Application Ser. No. 60/827,946 filed on Oct. 3, 2006 which is herein incorporated by reference.

### FIELD OF THE INVENTION

The present invention generally relates to storage systems and methods and, more particularly, to garage door panel mounting systems and methods thereof.

### BACKGROUND

In addition to motor vehicles, homeowners usually use their garages to store a variety of different types of indoor and outdoor items, such as bicycles, rakes, gardening tools, a lawn mower, automotive items, lawn chairs, and one or more ladders. Typically, the available storage space in a garage is limited.

To address this storage space problem, a variety of systems and devices have been developed to enable a homeowner to maximize the use of the available space in their garages. Most of these storage systems and devices are wall mounted and are used to store and organize a variety of different items on or adjacent the walls of the garage. Unfortunately, even with these systems and devices, many homeowners still do not have enough space in their garage to store their items, such as ladders.

### SUMMARY

A storage system for use on a garage door in accordance with embodiments of the present invention includes at least one retaining device and at least one latching device. The retaining device is attached to one of two or more panels of a garage door and the latching device is spaced from the retaining device and is attached to one of an item to be detachably secured and the one of the two or more panels of the garage door. The latching device has at least an engaged position which detachably secures an item to the one of two or more panels of the garage door with the retaining device and a detached position which releases the item from the one of two or more panels of the garage door.

A method for installing a storage system on a garage door in accordance with embodiments of the present invention includes securing at least one retaining device to one of two or more panels of a garage door and securing at least one latching device on the one of the two or more panels of the garage door at a location spaced from the retaining device. The latching device has at least an engaged position which detachably secures an item to one of an item to be detachably secured and the one of two or more panels of the garage door with the retaining device and a detached position which releases the item from the one of two or more panels of the garage door.

The present invention provides a number of advantages including providing a garage door panel mounting system which is very easy to use to detachably mount and to dismount items, such as a ladder, to the back of a garage door panel. The garage door panel mounting system helps to reduce clutter and increases the amount of usable storage space in a garage.

### BRIEF DESCRIPTION OF THE DRAWINGS

FIG. 1 is a back view of a garage door panel mounting system in accordance with embodiments of the present invention secured on a backside of a garage door;

FIG. 2A is a cross-sectional view of the garage door panel mounting system shown in FIG. 1 taken along line 2A-2A;

FIG. 2B is a cross-sectional view of the garage door panel mounting system shown in FIG. 1 taken along line 2B-2B;

FIG. 2C is a cross-sectional view of the garage door panel mounting system shown in FIG. 1 taken along line 2C-2C;

FIG. 3 is a back view of the garage door panel mounting system shown in FIG. 1 securing a ladder;

FIG. 4A is a cross-sectional view of the garage door panel mounting system securing a ladder shown in FIG. 3 taken along line 4A-4A;

FIG. 4B is a cross-sectional view of the garage door panel mounting system securing a ladder shown in FIG. 3 taken along line 4B-4B;

FIG. 4C is a cross-sectional view of the garage door panel mounting system securing a ladder shown in FIG. 3 taken along line 4C-4C;

FIG. 5A is a side view of a compression spring latching device in an engaged position;

FIG. 5B is a side view of the compression spring latching device shown in FIG. 5A in a detached position;

FIG. 6A is a side view of a tension spring latching device in an engaged position;

FIG. 6B is a side view of the tension spring latching device shown in FIG. 6A in a detached position;

FIG. 7 is a side view of a toggle latching device in an engaged position;

FIG. 8A is a side view of a push-pull type, toggle latching device in a detached position;

FIG. 8B is a side view of the push-pull type, toggle latching device shown in FIG. 8A in an engaged position;

FIG. 8C is a side view of a push-pull type, toggle latching device secured to a ladder and in a detached position;

FIG. 8D is a side view of the push-pull type, toggle latching device shown in FIG. 8C in an engaged position;

FIG. 9 is a perspective and exploded view of a retaining device for the garage door panel mounting system shown in FIG. 1 for a wooden garage door panel;

FIG. 10 is a perspective and exploded view of another retaining device for the garage door panel mounting system shown in FIG. 1 for a metal garage door panel;

FIG. 11 is a back view of a garage door panel mounting system in accordance with other embodiments of the present invention secured on a backside of a garage door;

FIG. 12 is a back view of a garage door panel mounting system in accordance with yet other embodiments of the present invention secured on a backside of a garage door;

FIG. 13A is a cross-sectional side view of a telescoping retaining device mounted on a metal garage door panel;

FIG. 13B is a front view of a top portion of the telescoping retaining device shown in FIG. 13A;

FIG. 13C is a perspective view of a bottom portion of the telescoping retaining device shown in FIG. 13A;

FIG. 14 is a back view of a garage door panel mounting system in accordance with other embodiments of the present invention secured on a backside of a garage door;

FIG. 15 is a back view of a garage door panel mounting system in accordance with yet other embodiments of the present invention secured on a backside of a garage door;

FIG. 16 is a back view of a garage door panel mounting system in accordance with yet further embodiments of the present invention secured on a backside of a garage door; and

FIGS. 17A-17D are side views of the garage door panel mounting system securing a ladder with the garage door in closed, two partially open and completely open positions.

### DETAILED DESCRIPTION

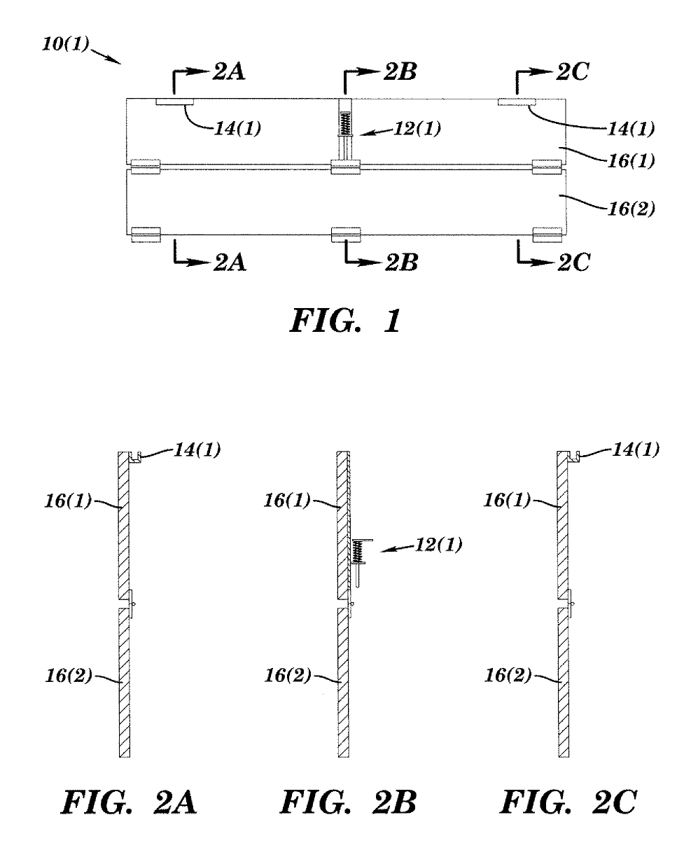

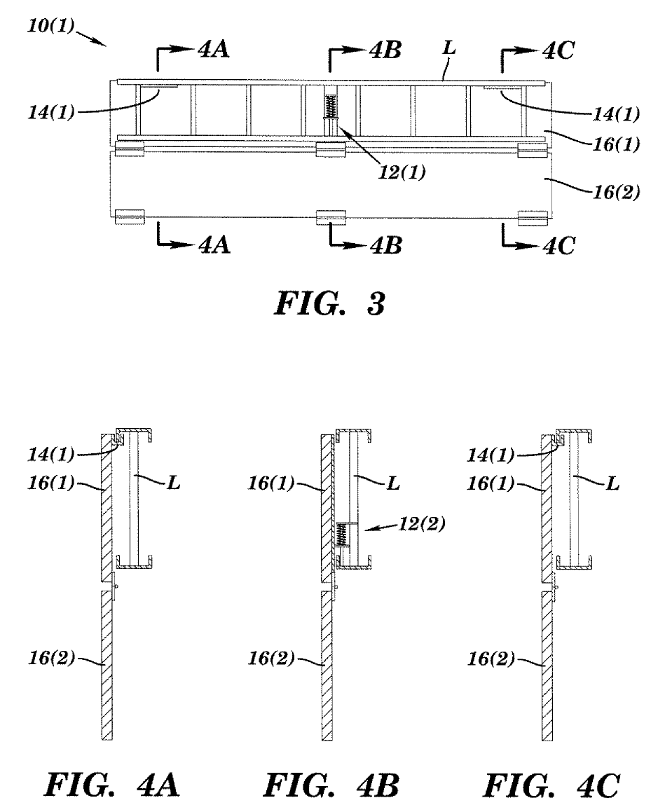

A garage door panel mounting system 10(1) in accordance with embodiments of the present invention is illustrated in FIGS. 1-4C and 17A-17D. The garage door panel mounting system 10(1) includes a latching device 12(1) and two retaining devices 14(1) which are mounted on garage door panel 16(1) of interconnected garage door panels 16(1)-16(4), although garage door panel mounting system can include other types and numbers of systems, device, and components connected in other manners. The present invention provides a number of advantages including providing a garage door panel mounting system which is very easy to use to detachably mount and to dismount items, such as a ladder L, to the back of a garage door panel.

Referring more specifically to FIGS. 1-4C, 5A, and 5B, the latching device 12(1)is substantially centered on and mounted adjacent a bottom edge of garage door panel 16(1), although other numbers and types of latching devices could be used which are mounted in other locations. By way of example only, the latching device 12(1) could be substantially centered on and mounted adjacent a bottom edge of garage door panel 16(1) with the retaining devices 14(1) mounted on the opposing edge of the garage door panel 16(1).

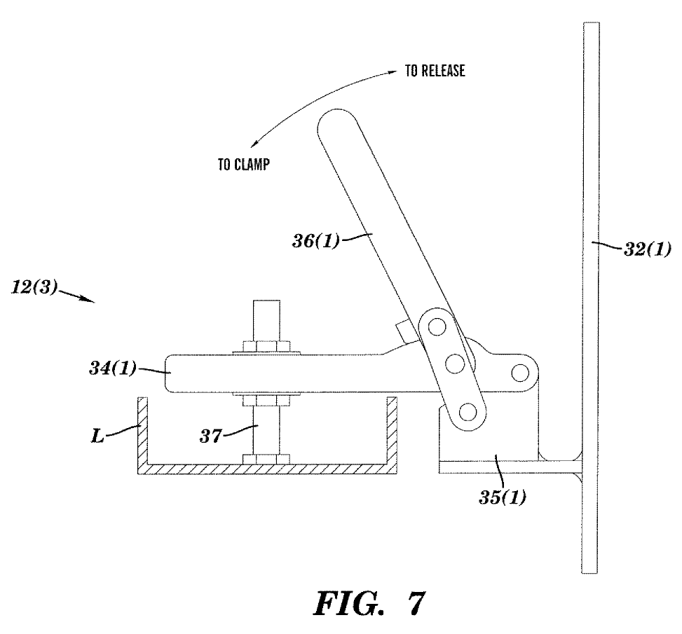

The latching device 12(1) includes a base 20, a plunger 24(1), and a compression spring 28, although latching device 12(1) can include other types and numbers of components connected in other manners. The base 20 is mounted to the garage door panel 16(1) and has a pair of guide structures 22(1) and 22(2) which extend out away from the base 20. Each of the guide structures 22(1) and 22(2) have an opening and these openings are substantially aligned with each other. A plunger 24(1) has a shaft 25 with an operating handle 27 at one end and a retainer structure 26 extending out from another portion of the shaft 25. The plunger 24(1) is mounted in the openings in the guide structures 22(1) and 22(2) for reciprocal motion between the engaged position shown in FIG. 5A and the detached position shown in FIG. 5B. A compression spring 28 is connected at one end to the guide structure 22(1) and at another end to the retainer 26. When the plunger 24(1) is in the detached position shown in FIG. 5B, the compression spring 28 biases the plunger 24(1) towards the engaged position shown in FIG. 5A.

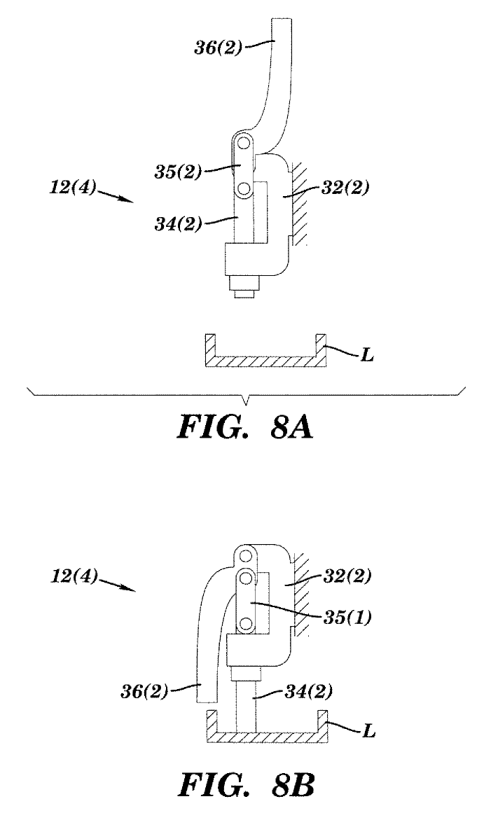

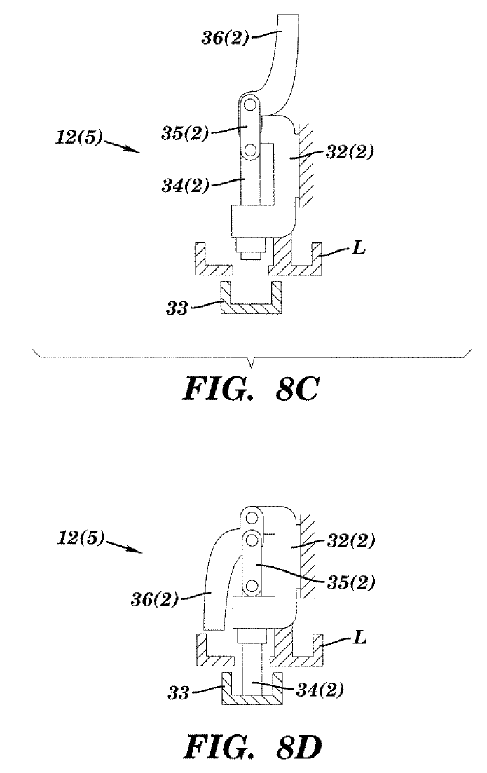

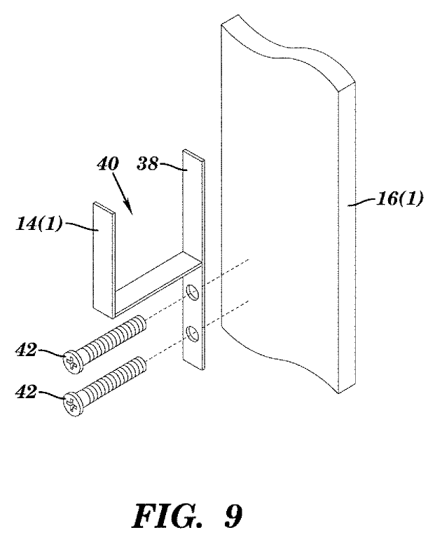

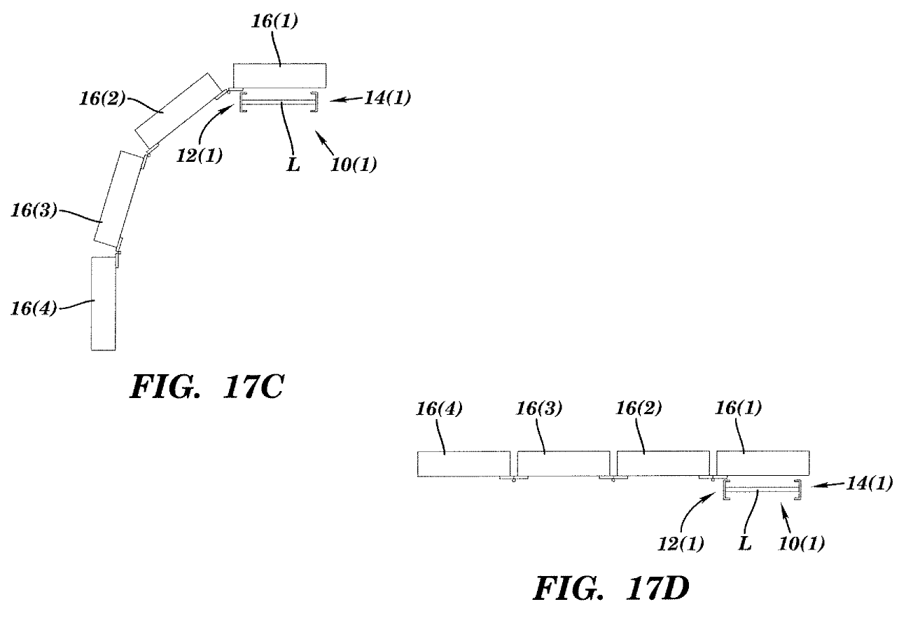

Although one type of latching device 12(1) is shown in FIGS. 1-5B, other types and numbers of latching devices can be used, such as the latching device 12(2) shown in FIGS. 6A and 6B, the latching device 12(3) shown in FIG. 7, or the latching device 12(4) shown in FIGS. 8A and 8B by way of example only. Additionally, the garage door panel mounting systems also can include one or more safety devices (not shown) to prevent accidental release by any of the latching devices. By way of example only, when the garage door panels 16(1)-16(4) begin any movement, such as that shown in FIGS. 17B-17D, the safety device can be triggered to lock the latching device in the engaged position to securely hold the item, such as a ladder L, in place.

The latching device 12(2) shown in FIGS. 6A and 6B is the same as the latching device 12(1) in structure and operation, except as described and illustrated herein. Elements in latching device 12(2) which are like those in latching device 12(1) will have like reference numerals and will not be described again in detail here. The latching device 12(2) has a plunger 24(2) with a shaft 25 that has an operating handle 27. The plunger 24(2) is mounted in the openings in the guide structures 22(1) and 22(2) for reciprocal motion between the engaged position shown in FIG. 6A and the detached position shown in FIG. 6B. A tension spring 28 is connected at one end to the operating handle 27 and at the other end to the guide structure 22(1). When the plunger 24(2) is in the detached position shown in FIG. 6B, the tension spring 28 biases the plunger 24(2) towards the engaged position shown in FIG. 6A.

The latching device 12(3) shown in FIG. 7 includes a base 32(1), a toggle arm 34(1), toggle connector 35(1), and a toggle handle 36(1), although latching device 12(3) can include other types and numbers of components connected in other manners. The base 32(1) is mounted to the garage door panel 16(1) and the toggle connector 35(1) is connected to the base 32(1). The toggle arm 32(1) includes an engagement rod 37 that seats against a portion of the ladder L in the engaged position and is spaced away from the portion of the ladder L in the detached position. The toggle arm 32(1) is pivotally connected to the toggle connector 35(1) for movement along an arc-shaped path from an engaged position shown in FIG. 7 to a detached position spaced away from the ladder L. The toggle handle 36(1) is pivotally mounted to the toggle support and is connected to and used to move the toggle arm 32(1) along the arc-shaped path between the engaged position shown in FIG. 7 to the detached position.

The latching device 12(4) shown in FIGS. 8A and 8B includes a base 32(2), a toggle arm 34(2), toggle connector 35(2), and a toggle handle 36(2), although latching device 12(4) can include other types and numbers of components connected in other manners. The base 32(2) is mounted to the garage door panel 16(1) and the toggle handle 36(2) is pivotally connected to the base 32(2). The toggle arm 34(2) is mounted in an opening in the base 32(2) for reciprocal and substantially linear motion between the detached position shown in FIG. 8A and the engaged position shown in FIG. 8B. The toggle connector 35(2) is pivotally connected at one end to the toggle arm 34(2) and at the other end to the toggle handle 36(2). The toggle handle 36(2) is used to move the toggle arm 34(2) along the substantially linear path between the detached position shown in FIG. 8A and the engaged position shown in FIG. 8B.

The latching device 12(5) shown in FIGS. 8C and 8D can be attached to the ladder L. The latching device 12(5) is the same in structure and operation as the latching device 12(4), except as described and illustrated herein. Elements in latching device 12(5) which are like those in latching device 12(4) will have like reference numerals and will not be described again in detail here. In this particular embodiment, the base 32(2) is mounted to the ladder L, instead of the garage door panel 16(1) and a retainer 33 is mounted to the garage door panel 16(1) at a spacing to mate with one end of the toggle arm 34(2) in the engaged position. The toggle arm 34(2) is mounted in an opening in the base 32(2) for reciprocal and substantially linear motion between the detached position shown in FIG. 8A and through an opening in the ladder L to the engaged position shown in FIG. 8B. The toggle handle 36(2) is used to move the toggle arm 34(2) along the substantially linear path between the detached position shown in FIG. 8C and the engaged position shown in FIG. 8D.

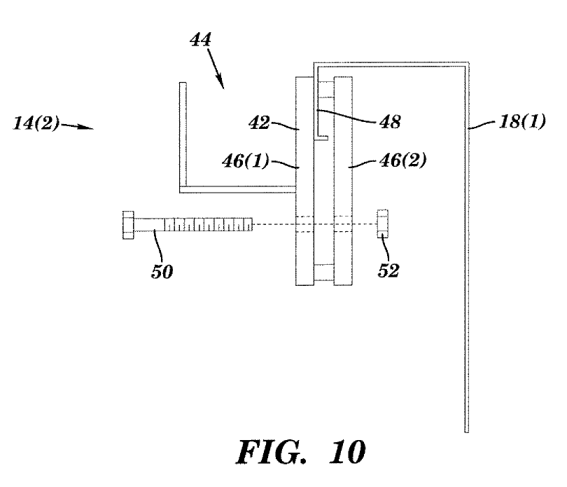

Referring to FIG. 1-4C and 9, the two retaining devices 14(1) are spaced out from the center of the garage door panel 16(1) and are secured to the garage door panel 16(1) adjacent an upper edge, although other numbers and types of retaining devices in other locations could be used. The two retaining devices 14(1) each comprise a bracket 38 which defines a square-shaped channel 40, although the bracket and channel can have other shapes and configurations. A pair of screws 42 are used to secure each of the retaining devices 14(1) to the garage door panel 16(1), although other manners for securing the retaining devices could be used.

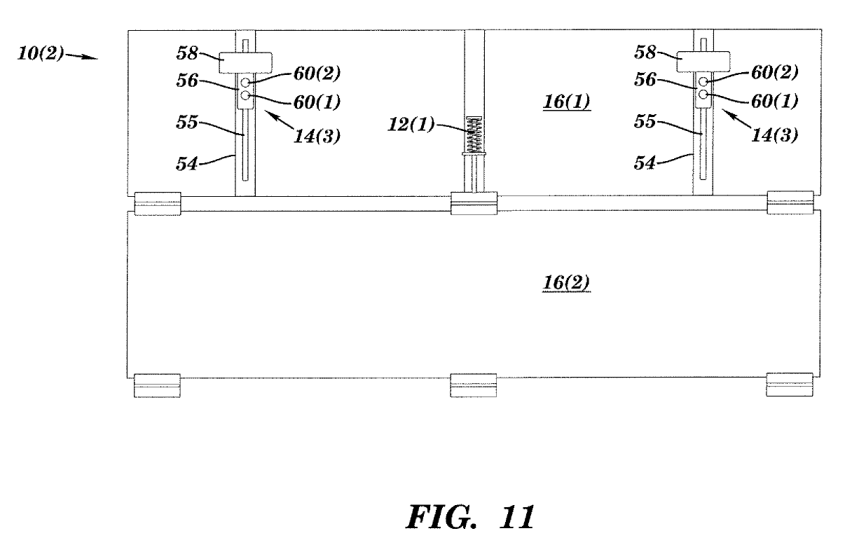

Referring to FIG. 10, a retaining device 14(2) for use with a metal garage door panel 18(1) is illustrated. The retaining device 14(2) comprises a bracket 42 which defines a square-shaped channel 44 for securing an item, such as part of a ladder L, although the bracket and channel can have other shapes and configurations. The bracket 42 has a mounting structure comprising a pair of structures 46(1) and 46(2) which are positioned on opposing sides of a lip 48 of metal garage door panel 18(1) and secured by a bolt 50 and nut 52, although other manners for securing the retaining device 14(2) to the metal garage door panel 18(1) could be used.

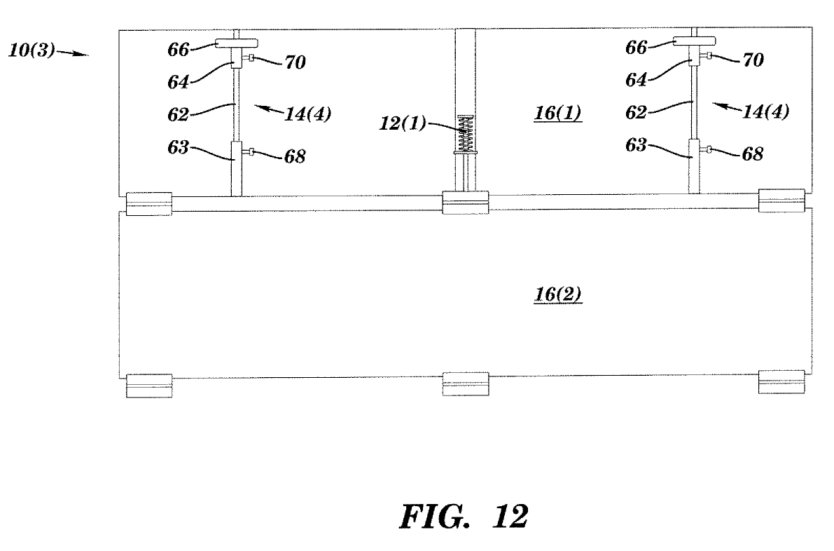

Referring to FIG. 11, another example of a garage door panel mounting system 10(2) in accordance with other embodiments of the present invention is illustrated. The garage door panel mounting system 10(2) is the same as the garage door panel mounting system 10(1) in structure and operation, except as described and illustrated herein. Elements in garage door panel mounting system 10(2) which are like those in garage door panel mounting system 10(1) will have like reference numerals and will not be described again in detail here. The garage door panel mounting system 10(2) includes the latching device 12(1) illustrated and described earlier and two retaining devices 14(3), although the garage door panel mounting system 10(2) can include other numbers and types of systems, devices, and components in other configurations.

The retaining devices 12(3) each comprise a guide rod 54, an adjustable sleeve 56, and a bracket 58, although the retaining devices 14(3) each can comprise other numbers and types of components in other configurations. The guide rod 54 is secured to the garage door panel 16(1) and the adjustable sleeve 56 is mounted for slidable movement on the guide rod 54 to enable the garage door mounting system to adjust for the particular size of the item, such as a ladder L, to be secured. The adjustable sleeve 56 is detachably secured in place by threaded bolts 60(1) and 60(2), although the adjustable sleeve could be detachably secured in place on the guide rod 54 in other manners. The bracket 58 is connected to the sleeve 56 and defines a square-shaped channel for securing an item, such as a ladder L, although the bracket and channel can have other shapes and configurations.

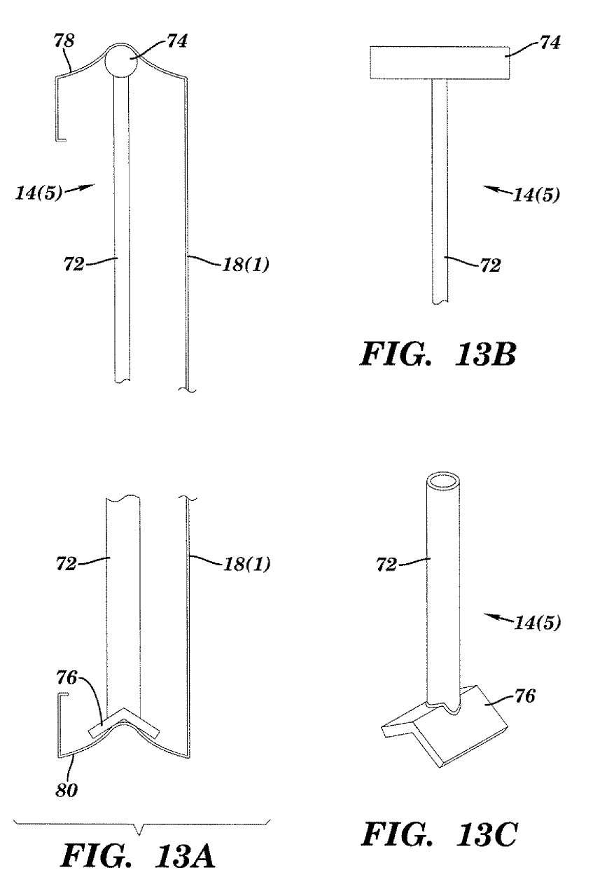

Referring to FIG. 12, another example of a garage door panel mounting system 10(3) in accordance with other embodiments of the present invention is illustrated. The garage door panel mounting system 10(3) is the same as the garage door panel mounting system 10(1) in structure and operation, except as described and illustrated herein. Elements in garage door panel mounting system 10(3) which are like those in garage door panel mounting system 10(1) will have like reference numerals and will not be described again in detail here. The garage door panel mounting system 10(3) includes the latching device 12(1) illustrated and described earlier and two retaining devices 14(4), although the garage door panel mounting system 10(3) can include other numbers and types of systems, devices, and components in other configurations.

Each of the retaining devices 14(4) comprises a telescoping guide rod 62, an adjustable sleeve 64, and a bracket 66, although the retaining devices 14(4) each can comprise other numbers and types of components in other configurations. The telescoping guide rod 62 is secured to the garage door panel 16(1) and the length of the telescoping guide rod 62 is adjustable and is detachably secured in place by bolt 68, although the telescoping guide rod 62 can be detachably secured to a particular length in other manners. The adjustable sleeve 64 is mounted for slidable movement on the telescoping guide rod 62. One or both the telescoping guide rod 62 and the adjustable sleeve 64 enable the garage door mounting system to adjust for the particular size of the item, such as a ladder L, to be secured. The adjustable sleeve 64 is detachably secured in place by threaded bolt 70, although the adjustable sleeve 64 could be detachably secured in place on the telescoping guide rod 62 in other manners. The bracket 66 is connected to the sleeve 64 and defines a square-shaped channel for securing an item, such as a ladder L, although the bracket and channel can have other shapes and configurations.

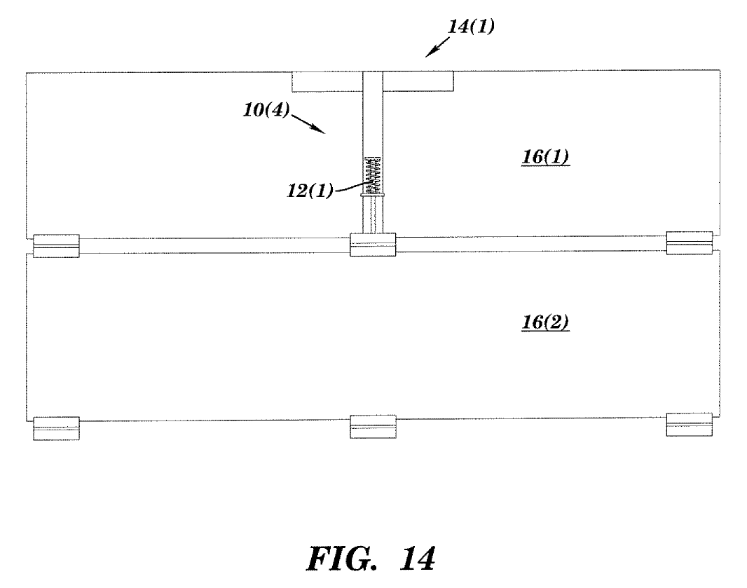

Referring to FIGS. 13A-13C, another example of a retaining device 14(5) which can be used with embodiments of the present invention is illustrated. The retaining device 14(5) is the same as the retaining device 14(4) in structure and operation, except as described and illustrated herein. Elements in retaining device 14(5) which are like those in latching device 14(4) will have like reference numerals and will not be described again in detail here. The retaining device 14(5) comprises a telescoping guide rod 72 for attachment to a metal garage door panel 18(1) and also an adjustable sleeve 64 and a bracket 66 which for ease of illustration are not shown here, but are the same as described with reference to FIG. 12, although the retaining device 14(5) can comprise other numbers and types of components in other configurations. The telescoping guide rod 72 includes a cross piece 74 at one end which mates with a lip 78 of the garage door panel 18(1) and an angle mount 76 at the other end which mates with a lip 80 of the garage door panel 18(1). The adjustable sleeve 64 can be mounted for slidable movement and detachably secured on the telescoping guide rod 72 as described earlier.

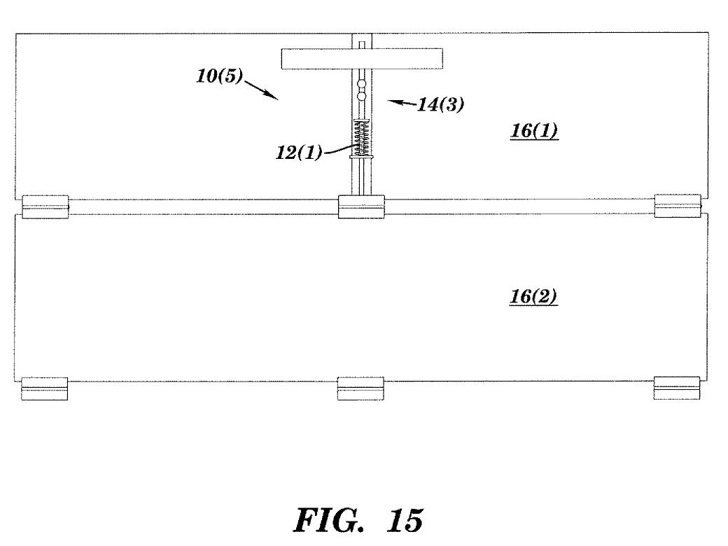

Referring to FIG. 14, another example of a garage door panel mounting system 10(4) in accordance with other embodiments of the present invention is illustrated. The garage door panel mounting system 10(4) is the same as the garage door panel mounting system 10(1) in structure and operation, except as described and illustrated herein. Elements in garage door panel mounting system 10(4) which are like those in garage door panel mounting system 10(1) will have like reference numerals and will not be described again in detail here. The garage door panel mounting system 10(4) includes the latching device 12(1) and one of the retaining devices 14(1) illustrated and described earlier, although the garage door panel mounting system 10(4) can include other numbers and types of systems, devices, and components in other configurations. In this particular embodiment, the retaining device 14(1) is substantially centered on the garage door panel 16(1) and is secured to the garage door panel 16(1)adjacent an upper edge, although other numbers and types of retaining devices in other locations could be used. In this particular embodiment, the retaining device 14(1) shown in FIG. 14 has a greater width than either of the retaining device 14(1) shown in FIGS. 1-4C.

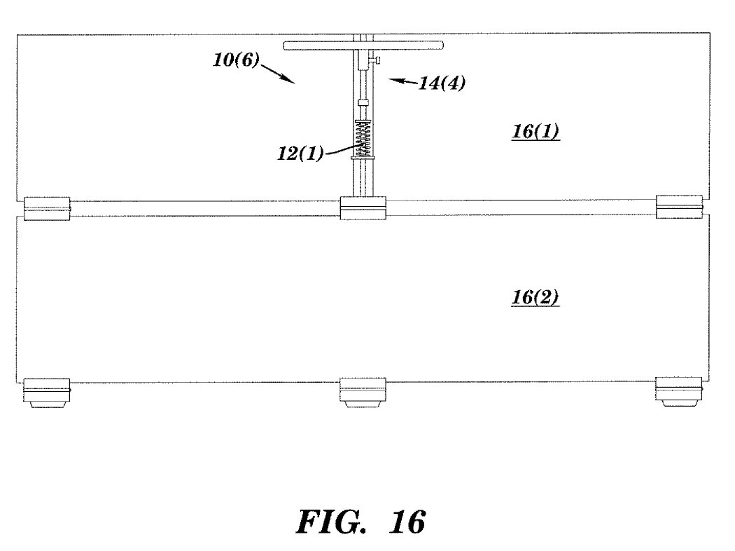

Referring to FIG. 15, another example of a garage door panel mounting system 10(5) in accordance with other embodiments of the present invention is illustrated. The garage door panel mounting system 10(5) is the same as the garage door panel mounting system 10(2) in structure and operation, except as described and illustrated herein. Elements in garage door panel mounting system 10(5) which are like those in garage door panel mounting system 10(2) will have like reference numerals and will not be described again in detail here. The garage door panel mounting system 10(5) includes the latching device 12(1) and one of the retaining devices 14(3) illustrated and described earlier, although the garage door panel mounting system 10(5) can include other numbers and types of systems, devices, and components in other configurations. In this particular embodiment, the retaining device 14(3) is substantially centered on the garage door panel 16(1) and is secured to the garage door panel 16(1)adjacent an upper edge, although other numbers and types of retaining devices in other locations could be used. In this particular embodiment, the retaining device 14(3) shown in FIG. 15 has a greater width than the retaining devices 14(3) shown in FIG. 11.

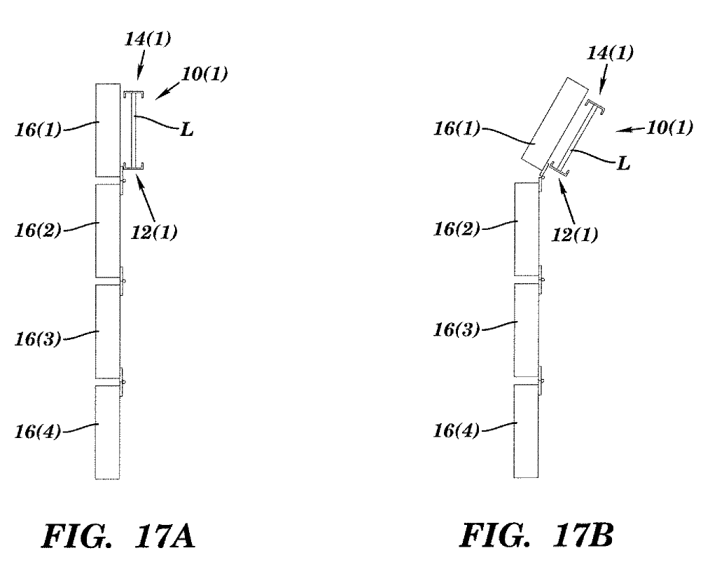

Referring to FIG. 16, another example of a garage door panel mounting system 10(6) in accordance with other embodiments of the present invention is illustrated. The garage door panel mounting system 10(6) is the same as the garage door panel mounting system 10(3) in structure and operation, except as described and illustrated herein. Elements in garage door panel mounting system 10(6) which are like those in garage door panel mounting system 10(3) will have like reference numerals and will not be described again in detail here. The garage door panel mounting system 10(6) includes the latching device 12(1) and one of the retaining devices 14(4) illustrated and described earlier, although the garage door panel mounting system 10(6) can include other numbers and types of systems, devices, and components in other configurations. In this particular embodiment, the retaining device 14(4) is substantially centered on the garage door panel 16(1) and is secured to the garage door panel 16(1) adjacent an upper edge, although other numbers and types of retaining devices in other locations could be used. In this particular embodiment, the retaining device 14(4) shown in FIG. 16 has a greater width than the retaining devices 14(4) shown in FIG. 12.

The installation and operation of the garage door panel mounting system 10(1) will now be described with reference to FIGS. 1-5B and 9. Two retaining devices 14(1) are mounted to and adjacent an edge of the garage door panel 16(1) with screws 42, although other numbers and types of retaining devices mounted in other locations can be used. Additionally, a latching device 12(1) is mounted to and adjacent an opposing edge of the garage door panel 16(1) from the retaining devices 14(1) with screws 42, although other numbers and types of retaining devices mounted in other locations can be used.

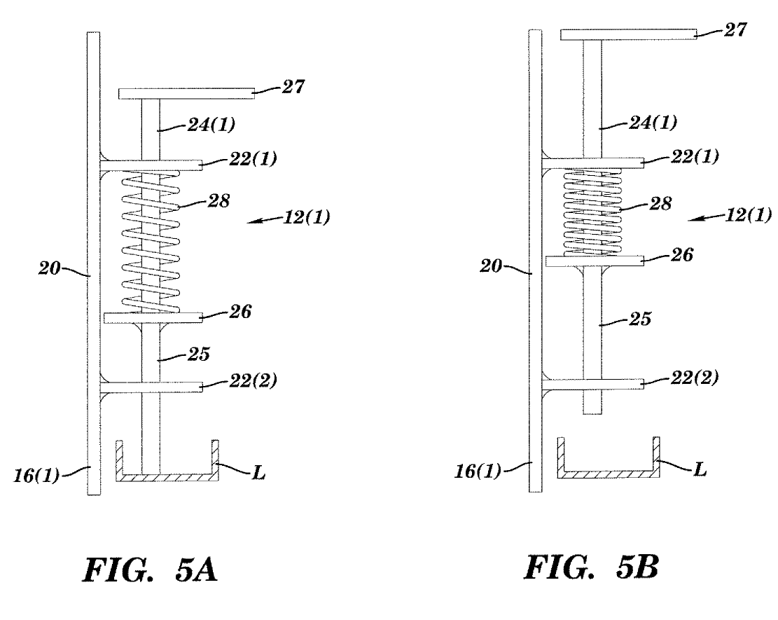

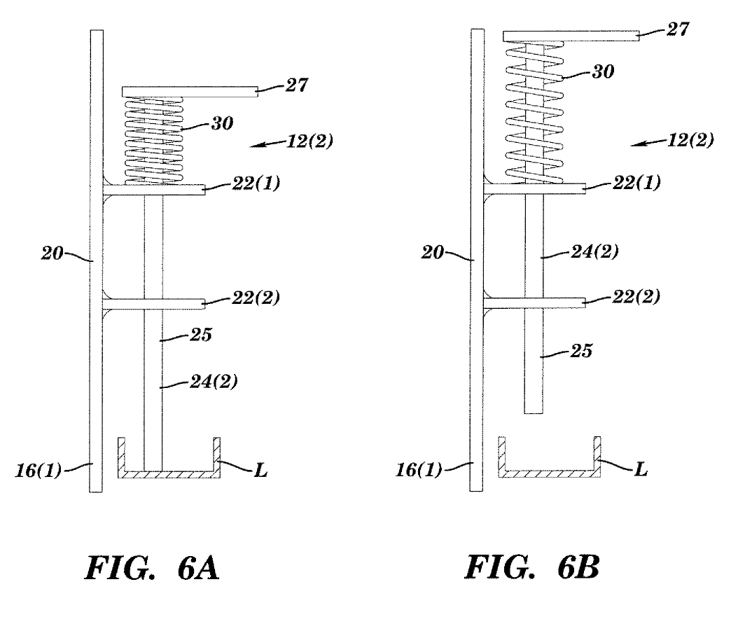

To mount an item, such as a ladder L, one side of the ladder L is hooked over the retaining devices 14(1) as illustrated in FIGS. 3-4C. Next, the operating handle 27 for plunger 24(1) can be pulled to the detached position shown in FIG. 5B which compresses the compression spring 28. The opposing side of the ladder L is positioned under the other retracted end of the plunger 24(1). When the handle 24(1) is released, the compression spring 28 moves the plunger 24(1) into the engaged position with the ladder L as shown in FIG. 5A. With the ladder L secured by the garage door panel mounting system 10(1) on garage door panel 16(1), the ladder L will move with the normal operation of the garage door as shown in FIG. 17A-17D.

The installation and operation of the garage door panel mounting systems 10(2)-10(6) is the same as for the garage door panel mounting system 10(1), except as described and illustrated herein. With respect to garage door panel mounting systems 10(2) and 10(3), the retaining devices 14(2) and 14(3), respectively can be mounted and adjusted as described earlier to accommodate storing different size items. With respect to garage door panel mounting systems 10(4)-10(6), only one retaining device 14(1), 14(3) or 14(4) is required and the retaining devices 14(3) and 14(4) can be mounted and adjusted as described earlier to accommodate storing different size items.

Accordingly, the present invention provides garage door panel mounting systems which are very easy to use to detachably mount and to dismount items, such as a ladder L, to the back of a garage door panel. With the present invention, the amount of usable storage space in a garage is increased.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A storage system for use on a garage door, the system comprising:
at least one retaining device which is attached to one of two or more panels of a garage door; and
at least one latching device which is spaced from the at least one retaining device and is attached to one of an item to be detachably secured and the one of the two or more panels of the garage door, wherein the latching device has at least an engaged position which detachably secures an item to the one of two or more panels of the garage door with the at least one retaining device and a detached position which releases the item from the one of two or more panels of the garage door.

2. The system as set forth in claim 1 wherein the at least one retaining device comprises a device with at least one channel.

3. The system as set forth in claim 2 wherein the at least one channel is elongated and extends along in at least a general direction of a width of the one of two or more panels of the garage door.

4. The system as set forth in claim 1 wherein the at least one retaining device further comprises at least two retaining devices which are attached to and spaced apart along the one of two or more panels of the garage door.

5. The system as set forth in claim 4 further comprising at least one bracket mounted to the one of the two or more panels of the garage door, wherein at least one of the at least two retaining devices is mounted for adjustable movement on the at least one bracket.

6. The system as set forth in claim 5 wherein the at least one bracket further comprises a bracket with a telescoping height adjustment system.

7. The system as set forth in claim 1 wherein the at least one latching device further comprises:
a base system attached to the one of the two or more panels of the garage door;
a plunger system mounted in the base system for movement between the engaged position and the detached position; and
a biasing system connected to the base system and the plunger system which biases the plunger to the engaged position.

8. The system as set forth in claim 7 wherein the biasing system comprises at least one of a compression spring and a tension spring.

9. The system as set forth in claim 1 wherein the at least one latching device further comprises:
a base system attached to the one of the two or more panels of the garage door;
a toggle arm mounted in the base system for movement between the engaged position and the detached position; and
a toggle handle pivotally connected to the toggle arm, wherein the toggle handle moves the toggle arm between the engaged position and the detached position.

10. The system as set forth in claim 9 wherein the toggle arm moves between the engaged position and the detached position in one of a substantially linear path and a substantially arc-shaped path.

11. A method for installing a storage system on a garage door, the method comprising:
securing at least one retaining device to one of two or more panels of a garage door; and
securing at least one latching device on one of an item to be detachably secured and the one of the two or more panels of the garage door at a location spaced from the at least one retaining device, wherein the at least one latching device has at least an engaged position which detachably secures an item to the one of two or more panels of the garage door with the at least one retaining device and a detached position which releases the item from the one of two or more panels of the garage door.

12. The method as set forth in claim 11 wherein the at least one retaining device comprises a device with at least one channel.

13. The method as set forth in claim 12 wherein the at least one channel is elongated and extends along in at least a general direction of a width of the one of two or more panels of the garage door.

14. The method as set forth in claim 11 wherein the securing at least one retaining device further comprises securing at least two retaining devices which are attached to and spaced apart along the one of two or more panels of the garage door.

15. The method as set forth in claim 14 wherein the securing at least two retaining devices further comprises mounting at least one bracket to the one of the two or more panels of the garage door and adjustably mounting at least one of the two retaining devices on the at least one bracket.

16. The method as set forth in claim wherein 15 the mounting at least one bracket further comprises mounting the at least one bracket with a telescoping height adjustment system.

17. The method as set forth in claim 11 wherein the securing at least one latching device further comprises:
attaching a base system to the one of the two or more panels of the garage door;
mounting a plunger system in the base system for movement between the engaged position and the detached position; and
connecting a biasing system to the base system and the plunger system which biases the plunger to the engaged position.

18. The method as set forth in claim 17 wherein the biasing system comprises at least one of a compression spring and a tension spring.

19. The method as set forth in claim I 1 wherein the securing at least one latching device further comprises:
attaching a base system to the one of the two or more panels of the garage door;
mounting a toggle arm in the base system for movement between the engaged position and the detached position; and
pivotally connecting a toggle handle to the toggle arm, wherein the toggle handle moves the toggle arm between the engaged position and the detached position.

20. The method as set forth in claim 19 wherein the toggle arm moves between the engaged position and the detached position in one of a substantially linear path and a substantially arc-shaped path.
